(19) United States
(12) Patent Application Publication
(10) Pub. No.: US 2024/0332545 A1
(43) Pub. Date: Oct. 3, 2024

(54) SECONDARY BATTERY

(71) Applicant: HONDA MOTOR CO., LTD., Tokyo (JP)

(72) Inventor: Terumi FURUTA, Saitama (JP)

(21) Appl. No.: 18/585,084

(22) Filed: Feb. 23, 2024

(30) Foreign Application Priority Data
Mar. 31, 2023 (CN) 202310336307.8

(51) Int. Cl. H01M 4/70

(52) U.S. Cl. CPC H01M 4/70

(57) ABSTRACT

To provide a secondary battery capable of reducing current density distribution. A secondary battery includes an electrode layer and an electrolyte layer. The electrode layer includes an electrode active material and a current collector. The current collector includes a region differing in thickness in a stacking direction of the electrode layer and the electrolyte layer, along a direction orthogonal to the stacking direction.

This application is based on and claims the benefit of priority from Chinese Patent Application No. 202310336307.8, filed on 31 Mar. 2023, the content of which is incorporated herein by reference.

### BACKGROUND OF THE INVENTION

### Field of the Invention

The present invention relates to a secondary battery.

### Related Art

In recent years, research and development have been conducted on secondary batteries that contribute to energy efficiency in order to ensure that more people have access to affordable, reliable, sustainable, and advanced energy.

The secondary battery has a structure in which an electrode layer and an electrolyte layer are stacked. The electrode layer includes a current collector. As the current collector, a foil-shaped or plate-shaped metal is used. Although a current collector having a uniform thickness is normally used as the current collector, to suppress variation in temperature distribution, a technique has been proposed in which the thickness of the current collector at a first position is made smaller than the thickness of the current collector at a second position having higher heat radiation than the first position, in a plane perpendicular to the stacking direction of the electrolyte layer (see Patent Document 1).
Patent Document 1: Japanese Unexamined Patent Application, Publication No. 2008-159330

### SUMMARY OF THE INVENTION

In the technique disclosed in Patent Document 1, to improve the heat radiation of the secondary battery, the thickness of the electrolyte layer at a position where the heat radiation is lower is increased, and conversely, the thickness of the current collector is decreased. On the other hand, the above configuration is suitable for a bipolar battery having low heat radiation in the central region, and cannot be said to be suitable for all secondary batteries.

Incidentally, when a secondary battery is mounted on a vehicle, the size of the secondary battery is required to be increased depending on applications. When the size of the secondary battery is increased, as the size of the current collector increases, a current density distribution inevitably occurs inside the battery. When a current density distribution occurs, particularly when a large current flows through the current collector, there arise issues such as local heat generation and non-uniform formation of dendrites. To deal with these issues, it is conceivable to control and cool the secondary battery. However, the above method is not only costly but also fails to eliminate the current density distribution itself.

In response to the above issue, it is an object of the present invention to provide a secondary battery capable of reducing current density distribution.

(1) A first aspect of the present invention relates to a secondary battery including an electrode layer, and an electrolyte layer. The electrode layer includes an electrode active material and a current collector. The current collector includes a region differing in thickness in a stacking direction of the electrode layer and the electrolyte layer, along a direction orthogonal to the stacking direction.

According to the first aspect of the invention, it is possible to provide a secondary battery capable of reducing current density distribution.

(2) In a second aspect of the invention according to the first aspect, the current collector continuously changes in thickness from one end part toward the other end part along the direction orthogonal to the stacking direction.

According to the second aspect of the invention, the current density distribution can be more preferably reduced.

(3) In a third aspect of the invention according to the first or second aspect, the current collector includes, along the direction orthogonal to the stacking direction, a facing part that faces an electrode active material layer including the electrode active material and a non-facing part that does not face the electrode active material layer. The non-facing part has a thickness that is larger than that of the facing part.

According to the third aspect of the invention, the current density distribution is reduced by gradually increasing the thickness of the current collector toward the end part where current flows in and out.

(4) In a fourth aspect of the invention according to the second aspect, a plurality of sets of the electrode layer and the electrolyte layer are stacked. The current collector includes a negative electrode current collector and a positive electrode current collector. The negative electrode current collector and the positive electrode current collector are arranged such that a region, having a small thickness in the stacking direction, of one of the negative electrode current collector or the positive electrode current collector, and a region, having a large thickness in the stacking direction, of the other of the negative electrode current collector or the positive electrode current collector are alternately arranged in the stacking direction. Thicknesses of a plurality of the negative electrode current collectors increase along the same direction. Thicknesses of a plurality of the positive electrode current collectors increase along the same direction.

According to the fourth aspect of the invention, the energy efficiency per volume of the secondary battery can be improved.

(5) In a fifth aspect of the invention according to the second or fourth aspect, a plurality of sets of the electrode layer and the electrolyte layer are stacked. The current collector includes a negative electrode current collector and a positive electrode current collector. The negative electrode current collector and the positive electrode current collector are arranged such that a region, having a small thickness in the stacking direction, of one of the negative electrode current collector or the positive electrode current collector, and a region, having a large thickness in the stacking direction, of the other of the negative electrode current collector or the positive electrode current collector are alternately arranged in the stacking direction. A plurality of the negative electrode current collectors have equal rates of change in thickness along the direction orthogonal to the stacking direction. A plurality of the positive electrode current collectors have equal rates of change in thickness along the direction orthogonal to the stacking direction.

According to the fifth aspect of the invention, the energy efficiency per volume of the secondary battery can be improved.

According to the present invention, it is possible to provide a secondary battery capable of reducing current density distribution.

### BRIEF DESCRIPTION OF THE DRAWINGS

FIG. 1 is a schematic sectional view showing the configuration of a secondary battery according to the present embodiment;

FIG. 2 is a schematic sectional view showing the configuration of a conventional secondary battery;

FIG. 3 shows a simulation model of the secondary battery according to the present embodiment; and

FIG. 4 is a graph showing simulation results of the secondary battery according to the present embodiment.

### DETAILED DESCRIPTION OF THE INVENTION

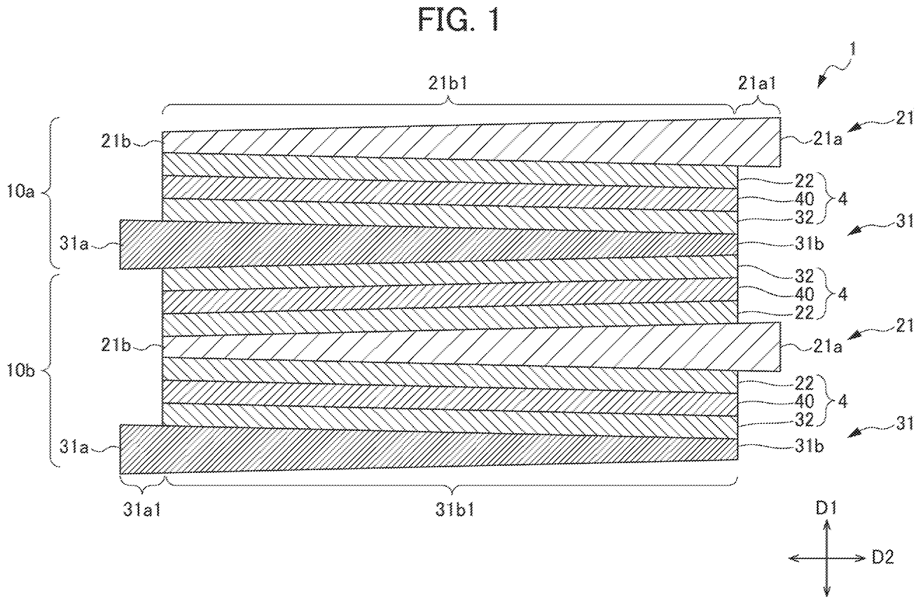

Hereinafter, an embodiment of the present invention will be described with reference to the drawings. As shown in FIG. 1, a secondary battery 1 according to the present embodiment is configured by stacking a plurality of secondary batteries 10a and 10b, which are minimum unit secondary batteries of the secondary battery. The minimum unit secondary battery is a set of a pair of electrode layers and an electrolyte. In FIG. 1, the number of the stacked minimum unit secondary batteries of the secondary battery 1 is 2, but the number of stacked secondary batteries is not limited.

### [Secondary Battery]

Examples of the secondary batteries 10a and 10b include, but are not limited to, lithium ion secondary batteries and lithium metal batteries that include lithium ions as the charge transfer medium and lithium metal batteries. Examples of the lithium ion secondary battery include a nonaqueous electrolyte battery including an electrolytic solution and a solid-state battery. Examples of the solid battery include a semisolid lithium ion battery including a gel electrolyte, and an all-solid-state lithium ion battery including a solid electrolyte.

The secondary batteries 10a and 10b are preferably lithium metal batteries. In the lithium metal battery, dendrites are likely to be formed in the negative electrode, and dendrites are formed non-uniformly when current density distribution occurs. As a result, the positive electrode and the solid electrolyte layer may move from a part where the amount of deposition of lithium metal is large toward a part where the amount of deposition of lithium metal is small, and the durability of the battery may be reduced. However, in the secondary battery according to the present embodiment, since the current density distribution can be reduced, it is considered that formation of dendrites in the lithium metal battery is likely to be made uniform.

Since the secondary batteries 10a and 10b include substantially the same components, the components of the secondary battery 10a will be described below. The components of the secondary battery 10b are denoted by the same reference numerals in the drawings, and descriptions thereof will be omitted.

As shown in FIG. 1, the secondary battery 10a includes electrode layers and an electrolyte layer 40. The negative electrode layer serving as an electrode layer includes a negative electrode active material layer 22 including a negative electrode active material serving as an electrode active material, and a negative electrode current collector 21 serving as a current collector. Similarly, the positive electrode layer serving as an electrode layer includes a positive electrode active material layer 32 including a positive electrode active material serving as an electrode active material, and a positive electrode current collector 31 serving as a current collector. The stacking direction of the electrode layers and the electrolyte layer 40 is the direction D1 in FIG. 1, and the direction orthogonal to the stacking direction is the direction D2.

The negative electrode current collector 21 is not limited, and examples thereof include copper foil. The detailed configuration of the negative electrode current collector 21 will be described later. The negative electrode active material layer 22 includes a negative electrode active material, and may further include a solid electrolyte, a conductivity aid, a binder, and the like.

Examples of the negative electrode active material include, but are not limited to, metallic lithium, a lithium alloy, a metal oxide, a metal sulfide, a metal nitride, Si, Sio, and a carbon material as long as the negative electrode active material can occlude and release lithium ions. Examples of the carbon material include artificial graphite, natural graphite, hard carbon, and soft carbon.

The positive electrode current collector 31 is not limited, and examples thereof include aluminum foil. The detailed configuration of the positive electrode current collector 31 will be described later. The positive electrode active material layer 32 includes a positive electrode active material, and may further include a solid electrolyte, a conductivity aid, a binder, and the like.

The positive electrode active material is not limited as long as it can occlude and release lithium ions. Examples of the positive electrode active material include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}CO_{4/6}Mn_{1/6})O₂, Li(Ni_{1/3}CO_{1/3}Mn_{1/3})O₂, LiCoO₄, LiMn₂O₄, LiNiO₂, LifePO₄, lithium sulfide, and sulfur.

When the electrolyte layer 40 includes a solid electrolyte, the solid electrolyte is not limited as long as it can conduct lithium ions. Examples of the solid electrolyte include an oxide-based solid electrolyte and a sulfide-based solid electrolyte.

When the electrolyte layer 40 includes an electrolytic solution, examples of the electrolytic solution include a nonaqueous electrolytic solution containing an organic solvent and a lithium salt. The organic solvent is not limited, and examples thereof include propylene carbonate, ethylene carbonate, and diethyl carbonate. The lithium salt is not limited, and examples thereof include LIPF₆, LiBF₄, LiClO₄, LiCF₃SO₃ (LiFSI), and LiN(SO₂F)₂ (LiTFSI). When the electrolyte layer 40 includes an electrolytic solution, a separator is preferably included. The separator may be impregnated with the electrolytic solution. As the separator, a known material such as a nonwoven fabric or a microporous film can be used.

### (Current Collector)

As shown in FIG. 1, the negative electrode current collector 21 as a current collector includes a non-facing part 21a1 that does not face the negative electrode active material layer 22 in the stacking direction D1, and a facing part 21b1 that faces the negative electrode active material layer 22 in the stacking direction D1. The negative electrode current collector 21 has different thicknesses in the stacking direction D1 at different positions along the direction D2 (hereinafter referred to as “orthogonal direction D2”) orthogonal to the stacking direction D1. In the present embodiment, the negative electrode current collector 21 is inclined so as to widen from an end part 21b on the side of the facing part 21bl to an end part 21a on the side of the non-facing part 21a1. Thereby, the thickness of the negative electrode current collector 21 continuously changes, increasing in thickness from the end part 21b on the side of the facing part 21b1 to the end part 21a on the side of the non-facing part 21a1.

As shown in FIG. 1, the positive electrode current collector 31 as a current collector has a configuration similar to that of the negative electrode current collector 21. That is, the positive electrode current collector 31 includes a non-facing part 31a1 that does not face the positive electrode active material layer 32 in the stacking direction D1, and a facing part 31b1 that faces the positive electrode active material layer 32 in the stacking direction D1. The thickness of the positive electrode current collector 31 continuously changes, increasing in thickness from an end part 31b on the side of the facing part 31bl to an end part 31a on the side of the non-facing part 31a1. In the present embodiment, the non-facing part 21a1 and the non-facing part 31a1 are formed at different end part sides to each other in the orthogonal direction D2. This makes it easy to form the secondary battery 10a such that the thickness of the secondary battery 10a in the orthogonal direction D2 is uniform.

A current collector tab, a lead tab, and the like are electrically connected to each of the non-facing parts 21a1 and 31a1. Accordingly, the end parts 21a and 31a are end parts on the sides where current flows into and out of the secondary battery 10a. That is, the current density distribution of the secondary battery 10a can be reduced by configuring the negative electrode current collector 21 and the positive electrode current collector 31 such that the thickness of the end part of each of the negative electrode current collector 21 and the positive electrode current collector 31 on the side where current flows in and out is relatively large. The reason for this will be described below.

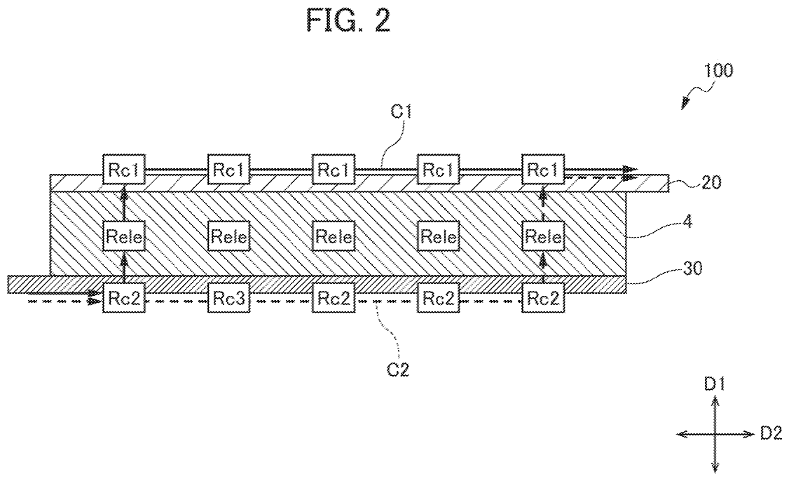

FIG. 2 schematically shows the configuration of a conventional secondary battery 100. The secondary battery 100 includes a negative electrode current collector 20, an electrode body 4, and a positive electrode current collector 30. The electrode body 4 is a layer in which the negative electrode active material layer, the electrolyte layer, and the positive electrode active material layer are stacked. The thickness of each of the negative electrode current collector 20 and the positive electrode current collector 30 in the stacking direction D1 is equal at all positions along the orthogonal direction D2.

In FIG. 2, the reference numeral “Rc1” denotes a resistance value per unit length of the negative electrode current collector. The reference numeral “Rc2” denotes a resistance value per unit length of the positive electrode current collector. The reference numeral “Rele” denotes a resistance value per unit length of the electrode body 4. Schematically, the resistance value of the energizing path C1 in FIG. 2 is Rc2+Rele+Rc1×5. Similarly, the resistance value of the energizing path C2 is Rc2×5+Rele+Rc1. Here, since the materials of the current collectors are different between the positive electrode and the negative electrode, the resistance value Rc1 differs from the resistance value Rc2. If Rc1<Rc2, the resistance of the energizing path C1<the resistance of the energizing path C2. Therefore, it is considered that current is likely to concentrate on the energizing path C1 and current density distribution occurs. If current density distribution occurs, a disadvantage such as non-uniform formation of dendrites may occur in the metal lithium battery, for example.

Here, the secondary battery 10a according to the present embodiment is configured such that the thicknesses of the end part 21a of the negative electrode current collector 21 and the end part 31a of the positive electrode current collector 31 on the sides where current flows in and out are respectively larger than the end parts 21b and 31b. As a result, since the resistance in the vicinity of the side of the current collector where current flows in and out is relatively low, even when Rc1<Rc2 in FIG. 1, for example, current flows more easily in the positive electrode current collector 31 in the orthogonal direction D2. This reduces the current density distribution in the secondary battery 10a.

The thickness difference a, which is each of the difference between the thickness of the end part 21a and the thickness of the end part 21b and the difference between the thickness of the end part 31a and the thickness of the end part 31b, varies depending on the material constituting each of the negative electrode current collector 21 and the positive electrode current collector 31, but is preferably 10 μm or more, and more preferably 20 μm or more.

The lengths of the negative electrode current collector 21 and the positive electrode current collector 31 in the orthogonal direction D2 vary depending on the materials constituting the negative electrode current collector 21 and the positive electrode current collector 31, and are not limited, but are preferably, for example, 500 mm or more. This is because the current density distribution of the secondary battery 10a is likely to be generated as the lengths of the negative electrode current collector 21 and the positive electrode current collector 31 in the orthogonal direction D2 increase, but according to the configuration of the present embodiment, the current density distribution of the secondary battery 10a can be reduced.

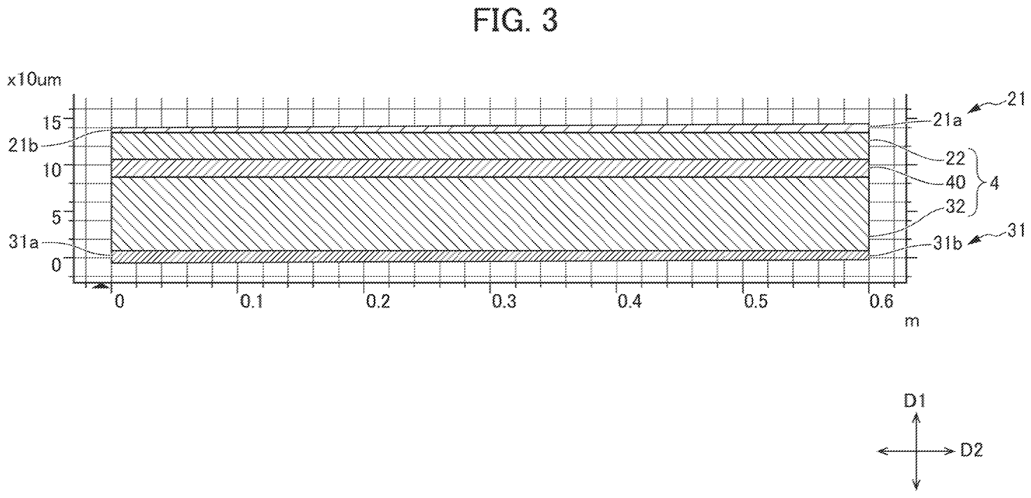

FIG. 3 shows a simulation model for performing current application calculation using an electrochemical model (Newman model base) and a 2D finite element method on the secondary battery 10a according to the present embodiment. The arrangement of the components in FIG. 3 corresponds to that of the components in FIG. 1. In FIG. 3, the material of the negative electrode current collector 21 is copper, and the thickness of the end part 21b side is 5 μm. The negative electrode active material layer 22 is a metallic lithium layer and has a thickness of 26.8 μm. The electrolyte layer 40 is a solid electrolyte layer and has a thickness of 20 μm. The positive electrode active material layer 32 has a thickness of 80 μm. The material of the positive electrode current collector 31 is aluminum, and the thickness of the end part 31b side is 7.5 μm. Current (equivalent to 1.7 C) is applied to the end part 31a. Current is drawn from the end part 21a and grounded. COMSOL Multiphysics (registered trademark) can be used as the current draw analysis software.

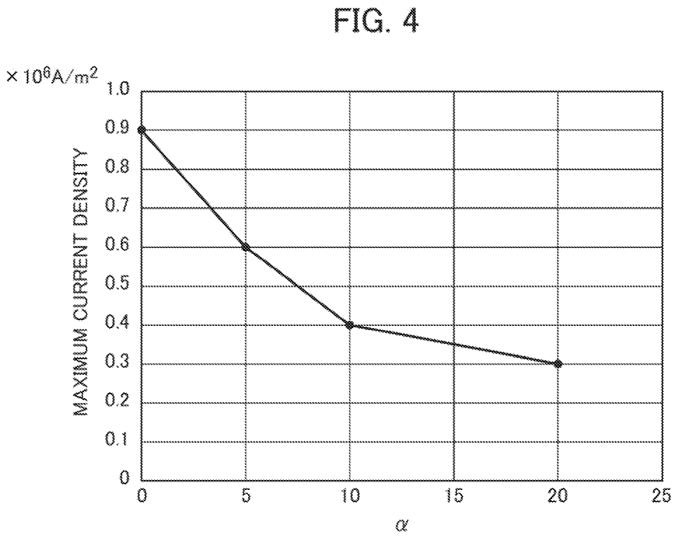

FIG. 4 is a graph showing the relationship between the thickness difference a and the maximum current density of the negative electrode active material layer 22 under the simulation conditions of FIG. 3 when the thickness difference a, which is each of the difference between the thickness of the end part 21a and the thickness of the end part 21b and the difference between the thickness of the end part 31a and the thickness of the end part 31b, is 0 μm, 5 μm, 10 μm, and 20 μm. The larger the maximum current density, the larger the current density distribution in the negative electrode active material layer 22.

Table 1 below shows the relationship between the thickness difference a and the current density of the electrolyte layer 40 under the simulation conditions of FIG. 3 when the above thickness difference a is 0 μm, 5 μm, 10 μm, and 20 μm.

TABLE 1

| Thickness difference α (μm) | | 0 | 5 | 10 | 20 |
|---|---|---|---|---|---|
| Current density | Minimum value A | 70 | 70.5 | 71 | 71.5 |
| of electrolyte | Maximum value B | 74 | 73.5 | 73.5 | 73 |
| layer 40 (A/m²) | B − A | 4 | 3 | 2.5 | 1.5 |

As shown in FIG. 4 and Table 1, as the thickness difference a is increased, the effect of reducing the current density distribution in the electrode body 4 is increased. In particular, under the simulation conditions shown in FIG. 3, it is clear that the current density distribution in the electrode body 4 can be preferably reduced by setting the thickness difference a to 10 μm or more.

The method of manufacturing the secondary battery 10a is not limited except that the current collectors according to the above embodiment are used as the current collectors, and a known method can be used. For example, the method includes a step of disposing an electrode material mixture containing an electrode active material on a surface of a current collector by a wet method or a dry method to form an electrode layer, a step of stacking an electrolyte layer and electrode layers to obtain a stack, and a step of pressing the stack.

As shown in FIG. 1, the secondary battery 1 includes the secondary batteries 10a and 10b, which are minimum unit secondary batteries. When a secondary battery is formed by stacking a plurality of minimum unit secondary batteries, the electrode body 4 may be disposed adjacent to another secondary battery like the secondary battery 10b.

The secondary battery 1 is housed in an exterior body. The exterior body is not limited, and examples thereof include a laminated film.

As shown in FIG. 1, in the secondary battery 1, a plurality of the negative electrode current collectors 21, the positive electrode current collectors 31, and the electrode bodies 4 are stacked such that the electrode body 4 is interposed between the negative electrode current collector 21 and the positive electrode current collectors 31. It is preferable that the upper surface and the lower surface in the stacking direction D1 of each of the plurality of minimum unit secondary batteries stacked of the secondary battery 1 are parallel to each other. As a result, the length of the secondary battery 1 in the stacking direction D1 is equal at all positions along the orthogonal direction D2. This makes it easy to arrange the minimum unit secondary batteries within the secondary battery 1 without a gap and also match the shape of the secondary battery 1 with the arrangement space. As a result, the energy efficiency per unit volume of the secondary battery 1 can be improved.

A configuration in which the upper surface and the lower surface in the stacking direction D1 of each of the plurality of stacked secondary batteries of the secondary battery 1 are parallel to each other is exemplified below. The negative electrode current collector 21 and the positive electrode current collector 31 each have a region with a small thickness and a region with a large thickness in the stacking direction D1, and are trapezoidal in sectional view. Therefore, for example, the negative electrode current collectors 21 and the positive electrode current collectors 31 are arranged such that the non-facing parts 21a1 and the non-facing parts 31a1 are alternately arranged on different end part sides in the orthogonal direction D2. It is preferable that the thicknesses of the plurality of negative electrode current collectors 21 increase along the same direction. In addition, it is preferable that the rates of change in thickness along the orthogonal direction D2 are equal. The plurality of negative electrode current collectors 21 may have the same shape. Similarly, it is preferable that the thicknesses of the plurality of positive electrode current collectors 31 increase along the same direction. In addition, it is preferable that the rates of change in thickness along the orthogonal direction D2 are equal. The plurality of positive electrode current collectors 31 may have the same shape. In addition, the shape of the electrode body 4 is made into a parallelogram in sectional view corresponding to the shapes of the negative electrode current collector 21 and the positive electrode current collector 31. However, it is preferable that each of the negative electrode active material layer 22, the electrolyte layer 40, and the positive electrode active material layer 32 has a uniform thickness in the stacking direction D1 along the orthogonal direction D2. According to the above configuration, the upper surface and the lower surface in the stacking direction D1 of the plurality of stacked secondary batteries of the secondary battery 1 can be made parallel to each other.

Although a preferred embodiment of the present invention has been described above, the present invention is not limited to the above embodiment, and various modifications and improvements are possible to the extent that the object of the present invention can be achieved.

### EXPLANATION OF REFERENCE NUMERALS

1 secondary battery
10a, 10b secondary battery (minimum unit secondary battery)
21 negative electrode current collector (current collector)
21a1 non-facing part
21b1 facing part
31 positive electrode current collector (current collector)
31a1 non-facing part
31b1 facing part
D1 stacking direction

What is claimed is:

1. A secondary battery comprising: an electrode layer; and an electrolyte layer,
the electrode layer comprising an electrode active material and a current collector, and
the current collector comprising a region differing in thickness in a stacking direction of the electrode layer and the electrolyte layer, along a direction orthogonal to the stacking direction.

2. The secondary battery according to claim 1, wherein the current collector continuously changes in thickness from one end part toward the other end part along the direction orthogonal to the stacking direction.

3. The secondary battery according to claim 1,
wherein the current collector comprises, along the direction orthogonal to the stacking direction, a facing part that faces an electrode active material layer comprising the electrode active material and a non-facing part that does not face the electrode active material layer, and
wherein the non-facing part has a thickness that is larger than that of the facing part.

4. The secondary battery according to claim 2,
wherein a plurality of sets of the electrode layer and the electrolyte layer are stacked,
wherein the current collector comprises a negative electrode current collector and a positive electrode current collector, and the negative electrode current collector and the positive electrode current collector are arranged such that a region, having a small thickness in the stacking direction, of one of the negative electrode current collector or the positive electrode current collector, and a region, having a large thickness in the stacking direction, of the other of the negative electrode current collector or the positive electrode current collector are alternately arranged in the stacking direction,
wherein thicknesses of a plurality of the negative electrode current collectors increase along the same direction, and
wherein thicknesses of a plurality of the positive electrode current collectors increase along the same direction.

5. The secondary battery according to claim 2,
wherein a plurality of sets of the electrode layer and the electrolyte layer are stacked,
wherein the current collector comprises a negative electrode current collector and a positive electrode current collector, and the negative electrode current collector and the positive electrode current collector are arranged such that a region, having a small thickness in the stacking direction, of one of the negative electrode current collector or the positive electrode current collector, and a region, having a large thickness in the stacking direction, of the other of the negative electrode current collector or the positive electrode current collector are alternately arranged in the stacking direction,
wherein a plurality of the negative electrode current collectors have equal rates of change in thickness along the direction orthogonal to the stacking direction, and
wherein a plurality of the positive electrode current collectors have equal rates of change in thickness along the direction orthogonal to the stacking direction.
